(19) United States
(12) Patent Application Publication
(10) Pub. No.: US 2012/0310868 A1
(43) Pub. Date: Dec. 6, 2012

(54) METHOD AND SYSTEM FOR EXTRACTING AND MANAGING INFORMATION CONTAINED IN ELECTRONIC DOCUMENTS

(76) Inventor: Alexandre Jonatan Berolli Martins, Florianopolis-SC (BR)

(21) Appl. No.: 13/579,264

(22) PCT Filed: Feb. 16, 2011
(86) PCT No.: PCT/BR11/00047

§ 371 Date: Aug. 16, 2012

(30) Foreign Application Priority Data
Feb. 19, 2010 (BR) PI 1000577-3

(51) Int. Cl. G06F 15/18

(52) U.S. Cl. 706/12

(57) ABSTRACT

A method and system that utilize metadata to facilitate extraction and enable management of information contained in electronic documents. Metadata describe content of documents based on composition of their structure and ways information is arranged in a structure. The system makes it possible to automatically manage models used for extraction, and metadata also define a logical schema for managing information extracted. The method includes a preparation step in which metadata and document samples are collected and stored, followed by a training step in which the system utilizes metadata and respective document samples to build and train models used for extraction. Finally, in an extraction step, the system receives a collection of documents and utilizes trained models to extract information that can be stored according to logical schema defined from metadata and can be immediately managed. The system enables methods to be applied to information dispersed throughout large documents. In one preferred embodiment, metadata is supplied by an XSD (XML Schema Definition) and document samples are labeled in a XML format that can be validated by the XSD.

### CROSS REFERENCE TO RELATED APPLICATION

This application is entitled to the benefit of international application PCT/BR2011/000047, filed on Feb. 16, 2011, designating the U.S.A. for national phase, which is entitled to a priority date of Feb. 19, 2010 from the Brazil application upon which the PCT is based, and the disclosures from both priority documents are incorporated herein by reference. This application is an English translation of the concepts and disclosures from both priority documents and is a Continuation-in-Part of PCT/BR2011/00047, which is entitled to an ultimate priority date of Feb. 19, 2010.

### TECHNICAL FIELD

The present invention relates to fields of information technology and information management. It also relates to natural language processing and machine learning techniques as applied to information extraction from electronic sources. More particularly, it relates to a method and system for extracting and managing information contained within documents.

### BACKGROUND ART

The amount of electronic documents has drastically increased in the last decades, making more evident the need to extract information contained in these documents. Within the context of this application's text and its claims, the terms “electronic document(s)” or simply “document(s)” refer to any grouping of data that can be processed, transferred, transmitted or made available by electronic means or devices, or a combination of these, which includes but is not limited to: text or binary files stored in one or more electronic memory devices, arrays of data obtained as an image of physical documents, data streams obtained from local or remote electronic sources, and the like. Information can be extracted from electronic documents with the assistance of computer programs that aim to identify the information of interest (i.e., information considered relevant to be extracted from documents) and make that information available in a structured format so that it could be used to fill in records, tables, or forms in a database format.

For situations where the document text presents some regularity, information extraction can be accomplished simply by a search based on regular expressions. Obviously, this approach is only effective when both the document format and its structure are well defined. As one intends to extract information from a collection of documents containing free-form language sentences of unknown structure and organization, more advanced techniques are required in order to identify the information of interest. One of these techniques is the implementation of rewriting rules capable of adding markup tags when applied to the text of a document. A few thousand rules may be required to deal with all possible variations of written language. Besides, such rules must be formulated by someone with knowledge about their syntax before they can be utilized by computer programs capable of interpreting and applying such rules to input documents. Therefore, solutions purely based on rewriting rules end up being too expensive to develop and are hard to maintain.

Recent research has devoted special attention to machine learning techniques. Such techniques allow computer programs to infer their own extraction rules from a set of examples provided to some sort of training process. Those examples, also called samples, are usually provided as labeled text, containing specific mark up (i.e., labels) within the text to indicate to which type of information a given word or text segment refers.

Latest machine learning techniques are based on statistical models, such as probabilistic state transition models (e.g. hidden Markov models) and feature-based classifiers. Techniques that utilize state transition models deal with each label as being a state assigned to the text token bound to that label, whereas the text itself is seen as a probable sequence of events capable of triggering a transition to a next state. Training such models consists in estimating transition probabilities from state transitions observed in samples. The trained model can then be applied to unlabeled text in order to add labels to it. Feature-based classifiers, in their turn, require the utilization of features. Features are usually implemented as binary functions, either preexisting functions that depend only on local textual attributes (for example, a function to test if the text font is bold or not) or through functions specifically coded for representing some particular knowledge about the domain in question (for instance, a function to test if the expression “author:” appears in the beginning of the sentence). In feature based classifiers, each output class corresponds to a label. Training consists in estimating the weights of each feature on the probability of each label, so that that the most probable label for the text token in question can be determined from the set of existing features relative to its positioning in the text.

There are also statistical learning techniques that combine aspects of the approaches mentioned above, as it described McCallum et Alli in “Maximum Entropy Markov Models for Information Extraction and Segmentation” (ICML-2000, PP. 591-598) and in “Conditional Random Fields: Probabilistic Models for Segmenting and Labeling Sequence Data” (ICML-2001, PP. 282-289). Such techniques allow features to be incorporated to statistical state transition models so that the probability of each label is conditioned not only on the probability assign to transitions, but also on the weights of features found in each state of the model.

Computer systems capable of extracting information from unstructured text generally employ one of the aforementioned techniques or a combination of such. As for the method employed in information extraction, it may vary according to the technique supported by the system being utilized. Nevertheless, in regard to statistical learning techniques in the art, which are of particular interest for the present invention, the method employed may be generalized in three steps: a preparation step, consisting of tasks required by the technique in question before a model can be trained, such as labeling samples, specifying possible states and transitions or coding functions to recognize features in the text; a training step, consisting of estimating the probabilities of the statistical model from data observed in samples; and a extraction step, which consists of applying a trained model to automatically label text sequences in order to extract the text associated with the labels of interest. Tests can be performed to evaluate the precision provided by a trained model. After extraction, the extracted information is usually stored in computer files or electronic databases (most likely in a relational database management system).

Information extraction systems that employ machine learning techniques are considered a trend for not submitting users to the arduous task of coding extraction rules. However, as mentioned in “Information Extraction: Distilling Structured Data from Unstructured Text” (ACM Queue, November 2005), the cost associated to labeling samples (i.e., to the preparation step) is still high, as a few hundreds of samples properly labeled may be necessary before an acceptable precision degree is reached. In systems that employ statistical learning techniques, the cost associated to implementing feature functions is also significant, particularly for those features that represent specific domain knowledge. Furthermore, for a system to recognize only valid label sequences, users may need to inform which state transitions are allowed within the model (when not informed, it would assume either that all state transitions are allowed or that it should only allow for transitions observed in samples).

Another common problem faced by information extraction systems is the difficulty to deal directly with large documents having hundreds or thousands of pages, where the information of interest is located in specific parts of the documents. The amount of computational resources required by sequence learning techniques to deal such large text sequences may be impracticable. Besides, a system could become unnecessarily inefficient for having to analyze irrelevant parts of the text. For cases like this, a preprocessing step that tries to extract segments of interest from the original document, such as sentences, paragraphs or even entire sections of that document, can be performed. However, such preprocessing step depends on domain knowledge and on the structure of the documents to be processed, which prevents it from being handled by a system in a generic way. In practice, before extracting information from large documents, one has to take care of breaking the extraction problem down into smaller sub-problems (the system will not handle it automatically). Usually some sort of classification or segmentation technique is employed to first identify relevant parts of the document and then submitting each of those parts to a more specialized extraction system.

In general, as little can be predicted about the organization and contents of unstructured documents, a solution for automatically extracting information incurs the cost of it being customized to a particular set of documents where some sort of standard structure is expected by its implementation. A way to compensate for that is to provide an additional description about the structure and information potentially found in documents prior to extracting it. Some previous work known in the art exercises this idea. For example, US-7493253 proposes the use of an ontology to represent domain knowledge as a way to help finding relevant facts that may be present in documents. Similarly to other approaches that propose ontology based solutions, the focus is on searching for text sequences containing facts that may be interrelated or related to ontology concepts, unconstrained by order or document structure. Although it has an admirable intent, modeling all the concepts that constitute an ontology, including relationships, rules, assertions, etc., around those concepts ends up being a much more complex task than simply labeling samples, which explains the difficulty in applying that type of solution to the problem of extracting information. U.S. Pat. No. 6,912,555 presents a method to automatically describe the structure of documents as a way to facilitate extraction. The proposed method is based on the assumption that hints about the structure of documents can be obtained from formatting features and graphical arrangement of document contents. Such hints are then appended to documents as a way to help finding the information of interest. One caveat is that this method expects documents to be “semi-structured”. When such visual or formatting features are not present in documents, its application becomes ineffective. Besides, even when it is possible to automatically obtain a description about the document structure from its graphical organization, the obtained description may not be relevant to the problem in question, leaving off details that are crucial for finding the information of interest within the text.

Information extraction systems and methods are not to be confused with specific extraction techniques in the art for digital library systems that are essentially cataloging techniques. For instance, to expedite storage of new scientific documents within a database, or other storage system, some authors utilize a pre-defined set of classifiers for defining the categories of a scientific document's contents. The classes recognized by such classifiers, while they may be characterized as “metadata” descriptions in one sense, are not the type of metadata capable in such systems of describing arrangements for documents' information and document structures themselves. Such extraction techniques also do not specify any sequence for extracting data portions from scientific document contents, and are not utilized by such systems to automatically generate models that are useful for extracting portions of the documents that include a particular content corresponding to information to be extracted and managed. Cross validation techniques utilized to estimate the precision of such classifiers in cataloging subject matter documents has nothing to do with validation of label sequences found in labeled documents, the later utilized within the context of this invention and referring to verifying whether label sequences are valid or not according to a set of predefined metadata or grammar.

Accordingly, there is a need for methods and systems for extracting and managing information contained in electronic documents. Self-learning systems that can use sample documents along with a description of the documents' structure to build models for efficiently extracting, storing and managing information located in electronic documents in a facilitated and accessible manner are particularly needed.

### SUMMARY OF THE INVENTION

Most of the difficulties involved in automatically extracting information from unstructured documents are due to the fact that very little is known about their structure and content. As mentioned above, existing solutions end up being tied to a set of documents for which they were designed. Furthermore, as information is extracted, there is the matter of managing that information. Most solutions simply assume that extracted information should be transferred to a database management system (DBMS). This kind of data transfer may turn out to be a complicate and time-consuming task. Besides requiring computer programs capable of transferring the extracted information to a DBMS, it also requires that a data model is already implemented to accommodate that information.

It is clear the need for a solution to address the difficulties around extracting and managing information contained in electronic documents in a more generic manner. More specifically, there is the need for a method and a system capable of:

reducing the cost associated to the preparation step, that is, reducing the cost involved in customization tasks such as labeling samples or any other tasks required by learning techniques, particularly with respect to writing code necessary to represent domain dependent knowledge and to the analysis and specification of valid sequences for the labels emitted by statistical models during the extraction process;

allowing their application and utilization to be instinctive and facilitated even by those who do not hold a profound knowledge on information extraction techniques, so that the choice of the techniques to be applied, as well as the tasks required by those techniques, can be carried out automatically and without needing any intervention from its users;

handling large documents containing potentially disperse information, without requiring users to implement or configure any preprocessing steps in order to extract relevant segments of such documents;

allowing information to be immediately managed as it is extracted, without the need to transfer that information to external database management systems or applications;

The solution given by the method and system that constitute the present invention is based on utilizing metadata to describe the contents of documents according to the composition of their structure and how the information of interest is arranged within that structure. Metadata is a generic term that refers to data about data. For the purposes of this invention, the whole set of relevant aspects described by metadata for a given document or collection of documents are referred hereinafter as metadata definition. The possible sequences or groupings of information and the data type associated with each information are some of the particular aspects described in a metadata definition, as well as any other aspects considered important to facilitate the extraction and management of the information contained in documents. As detailed below, a metadata definition not only allows extraction models to be automatically generated, but it can also provide a logical schema through which extracted information can be stored and managed.

The method begins with a preparation step in which a metadata definition and one or more document samples are collected and stored in the system. That metadata definition describes a structure for documents, indicating which elements constitute that structure, as well as information of interest contained in those elements. The elements that constitute the document structure correspond to any text segments whose contents are semantically linked. These elements may themselves contain other elements as sub-elements, thus forming nested structures. It is worth noting that sub-elements have the same capabilities as found in elements as they are themselves elements. The structure described in a metadata definition need not to reflect the original organization of a document, i.e., all of its sections, subsections, items, sub-items, and so on. However, it is important that such structure characterizes the possible sequences and groupings of information of interest contained in that document.

Next, in the training step, the metadata definition is utilized by the system to generate one or more models to be applied in extraction. Model parameters are then estimated according to certain properties observed in the samples provided in the preparation step. Multiple models capable of segmenting and extracting smaller and smaller portions of the text may be generated based on the structure described in the metadata definition, and then trained to successively reduce the scope onto the information of interest during extraction. Nevertheless, as the present invention is not restricted to a single extraction technique, the exact topology of generated models and which parameters need to be estimated will be determined by each possible system embodiment and the techniques it implements. Said system may provide ways to automatically select which technique to apply based on some configuration or data observed in the metadata definition and respective samples (e.g., the number of elements and sub-elements that compose the structure described in the metadata, the number of pages in each sample, the percentage of labeled text in samples, etc.). That can make system utilization facilitated and intuitive even for those who do not have a thorough understanding of extraction techniques applicable to the problem in question.

The models generated in the training step, as well as the values estimated for their parameters, are stored in the system. Such models remain associated with the metadata definition and respective document samples from which they were generated, thus enabling the system to apply the extraction step to the collection of documents represented by those samples.

Finally, in the extraction step, trained models are utilized by the referred system to extract information from documents. The extracted information is automatically validated and stored according to a logical schema that facilitates its management. Such logical scheme is also obtained from the metadata definition, either directly or through some correspondence relationship (for cases where the logical schema is defined in a different format or syntax than that utilized for the metadata definition). In any case, it is the metadata definition that ends up determining how stored information will be logically organized, and how it can be accessed for the purposes of querying, updating, or deleting it. Note that the exact commands or expressions utilized for managing that information will be specified by access interfaces available in each embodiment.

In summary, metadata describing documents are utilized all the way from preparation through to extraction and management and are crucial to the application and utilization of the method and system comprising the present invention. Besides providing a description that allows extraction models to be automatically generated, the metadata definition also works as a logical schema for managing the extracted information. The main innovative aspects of the present invention are therefore related to such metadata definition and to the way the referred system utilizes it during the application of the method.

The apparent innovations provided by this invention and their respective advantages are the following:

innovation: in the preparation step, metadata is utilized by the system to validate the contents of the samples; advantages: greater consistency and reliability in the preparation step, and consequent reduction of costs associated with the occurrence of incorrectly labeled samples;

innovation: in the training step, metadata is utilized by the system to automatically generate models to be trained and applied in the extraction step (or in labeling new samples); advantages: easiness and efficiency in the application of the method, since the user does not need to care about providing model parameters, or even be aware of which extraction techniques will be utilized by the system;

innovation: in the training step, metadata is utilized by the system to incorporate domain-dependent knowledge to the generated models; advantages: cost reduction in the preparation step, as the system does not require users to “manually” write in code for functions capable of expressing that knowledge;

innovation: in the training step, the structure described in a metadata definition is automatically utilized by the system to generate and train segmentation models that, when applied to documents during the extraction step, can identify relevant segments successively smaller, thus reducing the scope onto the information of interest; advantages: cost reduction in the application of the method as it prevents users from having to separately solve the problem of extracting relevant parts of documents, plus increased scalability, as the system is able to more efficiently handle cases where documents are large and their structure is complex or when the information to be extracted is located in specific parts of documents, as well as situations in which computing resources are limited;

innovation: the information extracted by the system is automatically validated, stored and managed according to a logical schema obtained from a metadata definition; advantages: integration and efficiency in the application of the method and consequent reduction of costs associated with managing extracted information, for it allows users to query or modify the stored information immediately after extraction using a logical schema they are already familiar with, without the need to convert them or transfer them to other database management systems.

Other aspects, innovations, and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates the method and system according to this invention. The double arrows indicate the sequence of steps of the method. The single arrows represent the expected inputs and outputs in each of the steps, indicating their flow throughout the system.

FIG. 2 presents an example of a metadata definition. Rectangles represent the elements that constitute the document structure. A single bordered rectangle indicates that such an element appears only once in the document, whereas a double bordered rectangle is utilized to indicate elements that may appear more than once in that document. The ellipses represent the information of interest to be extracted from documents.

FIG. 3 shows an example of an extraction model generated from a metadata definition, with its states and transitions. The states are represented by ellipses and the arrows indicate the transitions between states.

FIGS. 4A, 4B and 4C illustrate the process of generating models for successively segmenting document contents during extraction, based on decomposing the structure described in a metadata definition. FIG. 4A presents the generation of models for the first level of the structure being described. FIGS. 4B and 4C illustrate the generation of the models for the subsequent levels. For each level, the description of the structure appears on the left of the figure whereas the corresponding generated model (with its states and transitions) appears on the right.

### DESCRIPTION OF THE EMBODIMENTS

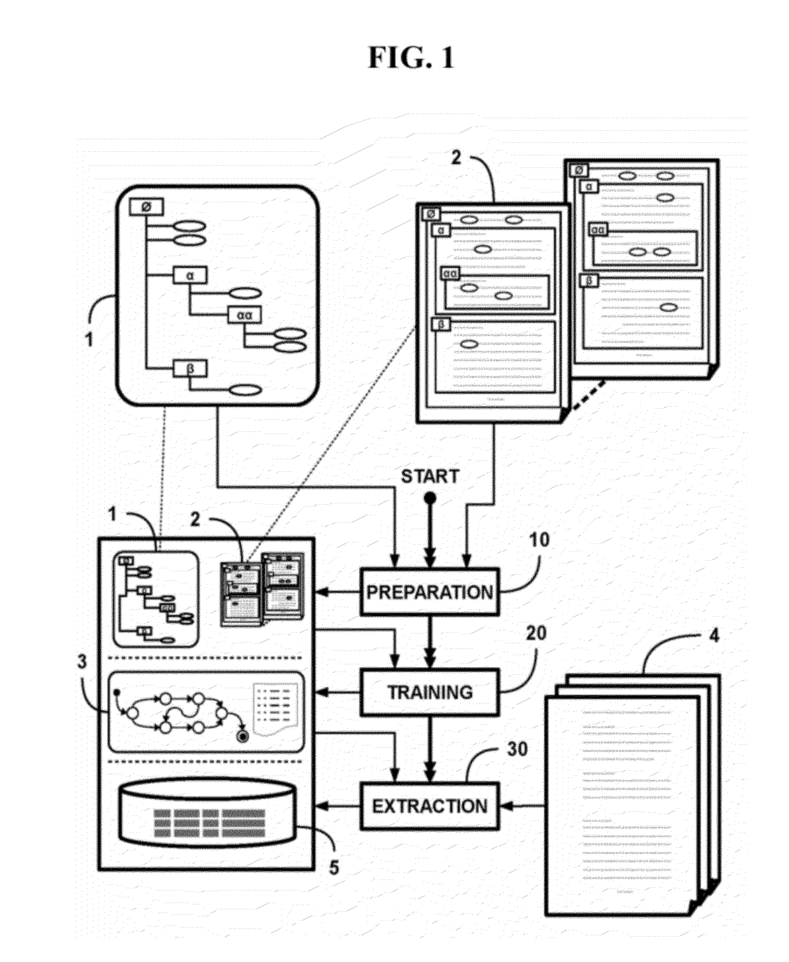

This invention provides a method and system for extracting and managing information contained in electronic documents that utilize metadata to describe aspects related to the structure and contents of such documents. FIG. 1 illustrates a general embodiment of the method and system according to this invention. The method begins with a preparation step (10) in which metadata (1) and document samples (2) are collected and stored in the system. Then, in the training step (20), the system utilizes said metadata (1) and respective document samples (2) to build and train models (3) to be applied in extraction. These models remain in the system, together with other data required by extraction techniques in use. Finally, in the extraction step (30), the system receives a collection of electronic documents (4) and utilizes the trained models (3) to extract information of interest. The extracted information is stored (5) by the system according to a logical scheme obtained from said metadata so it can be immediately managed.

As mentioned above, the terms “electronic document(s)” or simply “document(s)” herein refer to any grouping of data that can be processed, transferred, transmitted or made available by electronic means or devices, or a combination of these, which includes but is not limited to: text or binary files stored in one or more electronic memory devices, arrays of data obtained as an image of physical documents, data streams obtained from local or remote electronic sources, and the like. In a preferred embodiment, terms “document(s)” or “electronic document(s)” may refer to one or more electronic files that include information in the form of text, graphics (or both) that may be accessed and displayed or visualized by utilizing one or more of a word processor, email program, text editor and the like. Terms may also refer to content that may be browsed by utilizing a web browser, html editor or other web page viewer program or by similar information access logic. In some instances “electronic document” may refer to an electronic file of information that has been captured and saved by software or hardware logic that captures and saves a portion of an electronic data stream or of an electronics communication stream.

In one possible embodiment, the definitions required for the metadata to be created in the system are provided separately (by external users or systems). In another embodiment, said metadata is obtained directly from elements (e.g. tags, labels, titles, words, etc.) found within contents of document samples. In those or any other possible embodiments, said metadata are considered logically independent from the documents they describe, and the artifacts utilized to define such metadata are collectively referred to as metadata definition. In a preferred embodiment, a metadata definition is created, stored and maintained separately by the system. For each collection of documents that share information of interest and that will be submitted to extraction, there is a metadata definition describing documents in that collection.

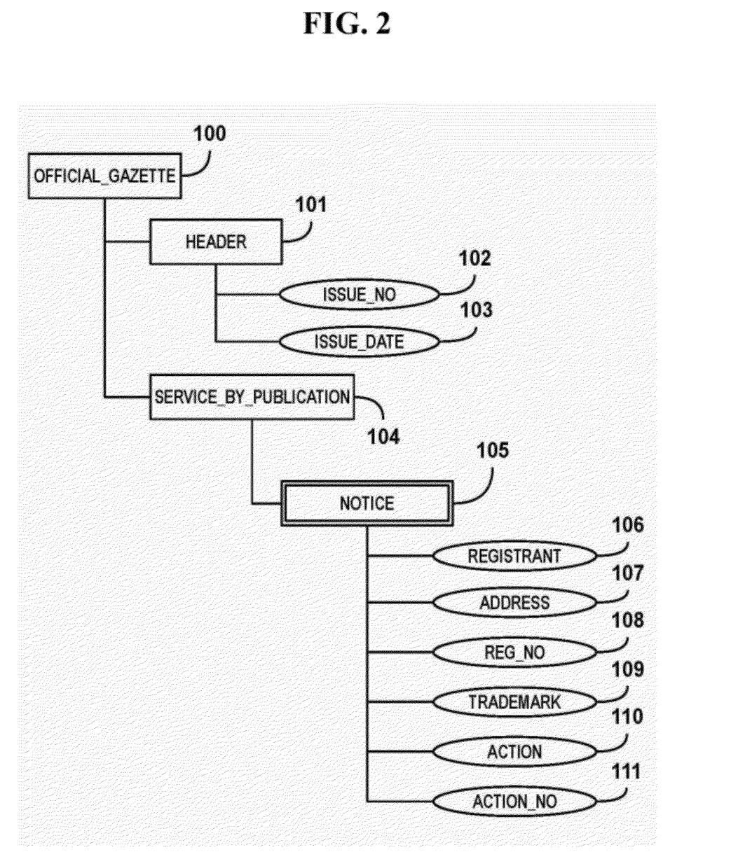

FIG. 2 shows an example of metadata definition describing a hypothetical Official Gazette document issued by the Trademark Office. In this example, rectangles represent elements forming a document structure whereas ellipses represent information of interest to extract for those elements. Assume such metadata definition was provided for an application program that has the goal of extracting information specific to the section of service by publication notices (i.e., opposition or cancellation notices on trademark applications filed) found in that document. The header element (101) is described as containing an issue number (102) and corresponding issue date (103). The element that describes the service by publication section (104) is constituted by another element describing one or more notices (multiple occurrence is depicted as a double bordered rectangle). For each notice (105) the information of interest is described, namely: registrant's name (106), registrant's address (107), registration number (108), trademark (109), type of action (110) and action number (111). This example assumes that the information contained elsewhere in the document is not relevant to the application program in question, which is why other sections of the document do not appear described in this metadata definition. Note that the graphical representation utilized in FIG. 2 has illustrative purposes only. Although not shown in this example, possible embodiments of this invention should allow additional descriptive aspects to be included in the metadata definition such as the type of grouping that elements or information of interest are expected to follow within the text (sequential or random), their number of occurrences (minimum and maximum) and the data type associated with each information of interest to be extracted (e.g. numeric, alpha-numeric, character, or even a more specialized data type).

In a preferred embodiment, metadata are utilized in the preparation step to establish the possible sequences for labels to appear in the text of the samples. Therefore, a given label may only appear in the text of samples when the respective information is described in the metadata definition associated to those samples and it follows the ordering established by such metadata. If necessary, a metadata definition should be modified to accommodate all possible sequences of labels observed in samples. For example, if in a given sample the label issue_number precedes the label issue_date, but in another sample such labels appear in the reverse order, the corresponding metadata definition should be relaxed so as not to impose a specific ordering to these labels. Further, when a metadata definition assigns data types to the information of interest being described, the contents bound to corresponding labels in samples must conform to those data types. In another preferred embodiment, the system must validate samples by verifying that their contents agree with what was described in the metadata definition associated to those samples, and report any inconsistencies found. Said system may also report the changes in that metadata definition necessary to conform to sample contents and offer, where possible, the option to perform these changes automatically.

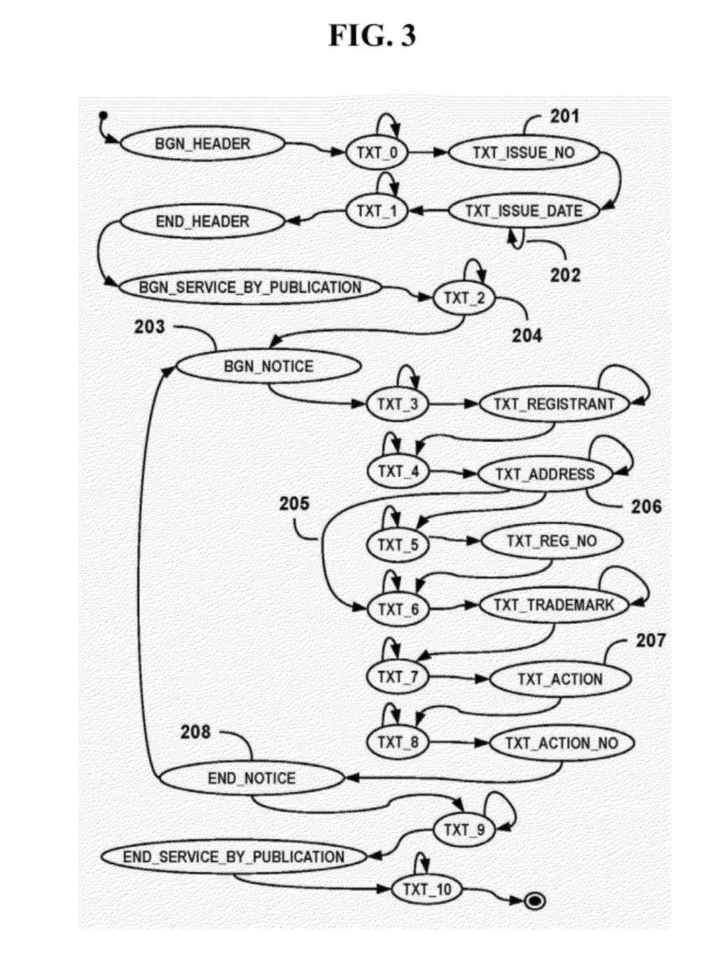

In another preferred embodiment, a metadata definition and associated samples are utilized in the training step to generate and train one or more extraction models. FIG. 3 shows an illustrative example of a model generated from the metadata definition in FIG. 2. The topology of the model generated in this example is essentially a state machine that specifies the valid sequences of states (i.e., labels) to be assigned to an input text as transitions are fired. Two states have been generated for each element in that metadata definition: a initial state and a final state. These states, named BGN_elem and END_elem (where elem is the name of the corresponding element), are utilized by the system to recognize the beginning and the end of the text related to that element (e.g. states (203) and (208) generated to recognize the beginning and end of a trademark notice). States named TXT_inf (where inf is the name of the corresponding information) have been generated for each information of interest described in that metadata definition (e.g., state (201) which recognizes the official gazette issue number). Other states, called TXT_n (where n is simply a sequential number that identifies the state) were artificially introduced into the model to allow the system to process text content considered irrelevant to the application (e.g. the state (204) utilized to recognize the preamble of the service by publication notices section preceding the first notice). Transitions between states were introduced in the model taking into account the sequences in which elements and respective information might occur in the text according to that metadata definition. For instance, transition (205) connecting registrant's address (206) directly to the text preceding the trademark (207) was added to the model due to registration number is described as an optional information in the metadata definition (this example assumes there might be entries where a registration number is not available yet). Note this generated model expects a transition to be triggered for every new token that appears in the text. Therefore, cyclic transitions were also included to recognize information whose value consists of multiple tokens (e.g. the cyclic transition (202) added to the state corresponding to the issue date for recognizing the various tokens that constitute that date, i.e., month, day, year, separators, etc., as being part of the same information).

In another possible embodiment, the metadata definition and associated samples are utilized to enrich a generated model based on certain textual features that are dependent on domain knowledge. When expressed in a metadata definition, such features can be incorporated into the model as additional parameters such as other states and transitions, binary features, regular expressions, etc., depending on the extraction technique in use. Having features that express domain knowledge in the generated model may help increasing precision during extraction. Assume, for example, the type of action in each trademark notice has only tree possible values: Cancellation, Opposition and Expiration. Now assume that this knowledge is expressed in the metadata definition by some specialized data type (e.g. an enumerated action type). By analyzing that data type, the system can automatically generate binary feature functions such as is_cancellation, is_opposition and is_expiration to indicate whether a given text token corresponds to some of the actions listed in that data type. Note that domain aware features can be combined and incorporated into the generated model along with other features observed in samples that do not rely on domain knowledge (e.g. the text is bold, the first letter is capitalized, etc.).

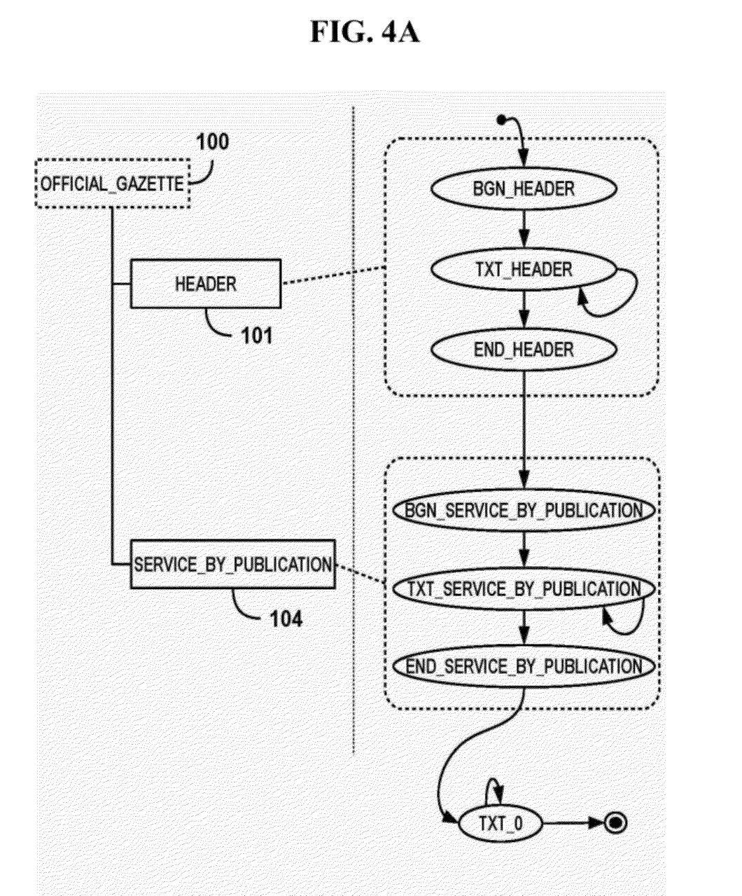

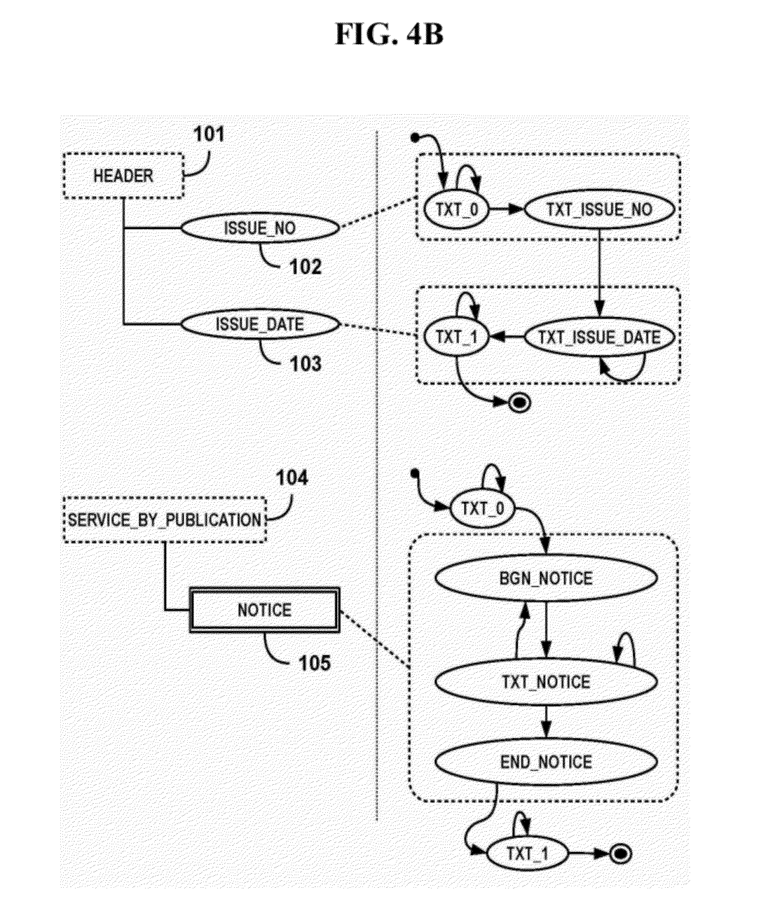

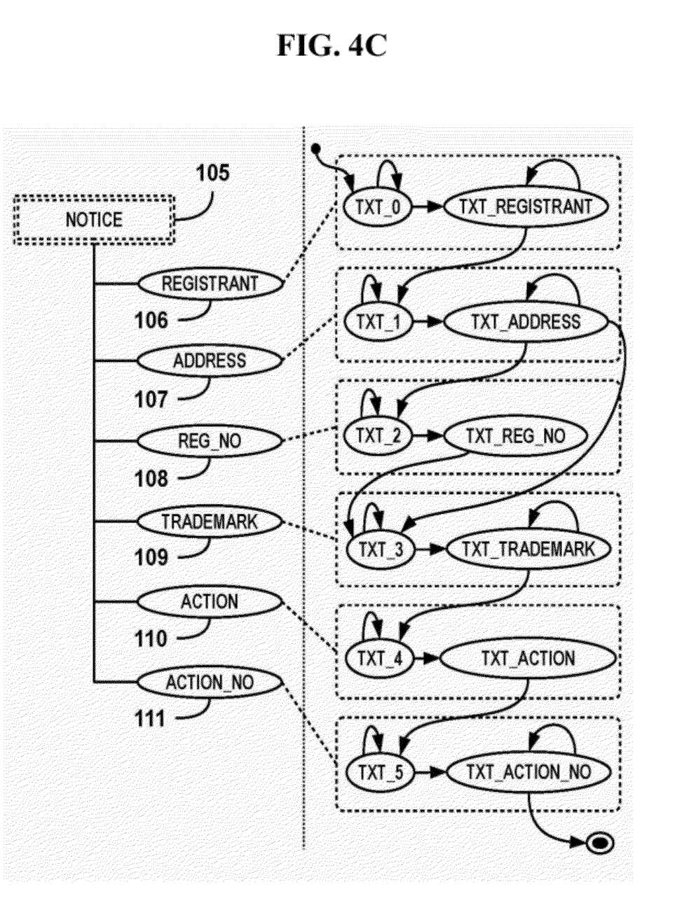

In yet another preferred embodiment the system generates and trains multiple models capable of breaking down document contents according to the structured described in a metadata definition. Thus, instead of a single linear model (as the one shown in FIG. 3), several models are generated by decomposing the structure described in the metadata definition according to elements present in each of its composition levels. To illustrate this process, assume that the metadata definition in FIG. 2 describes a structure that is loaded into the system memory like a tree, where the element (100) is the root of that tree. In this example, the first level comprises elements (101) and (104) that descend from the root element (i.e., children of the root), the second level comprises information (102) and (103) and the element (105) (all grandchildren of the root element), and so on. At each level in the document structure, a model is generated for each group of elements or information descending from the same element at the level immediately above (i.e., the elements that have the same parent element will be part of the same model). FIG. 4A illustrates this process for the first decomposition level (containing the children of the root) for the structure shown in FIG. 2. FIGS. 4B and 4C, respectively, illustrate the same process for the second and third levels of decomposition. During extraction, smaller and smaller segments are automatically extracted from the document by successive applying the generated model, i.e., the document gets segmented according to the nested structure that defines it, until the finest level is reached, which in this case is the level containing the information of interest. This segmentation strategy is particularly interesting when documents are very large or when the information to be extracted is located in specific portions of the text, as it avoids the unnecessary processing of irrelevant parts of the document, promoting the efficiency of the method as a whole. In this embodiment, large documents with dispersed information can be processed without requiring that users execute or configure preprocessing steps in order to extract the relevant segments. Yet in this embodiment, distinct extraction techniques may be applied at each level of the structure described in the metadata definition. For example, at the first level, a simple linear classifier might be utilized to determine whether or not a text segment belongs to the service by publication notices section. At the second level, a maximum entropy classifier is applied to classify the text segment extracted at the first level as being or not the text of a notice. Finally, at the third level, a technique based on probabilistic automata is utilized to decode and label the sequence of information in each segment extracted at the previous level (each of these segments containing the text of a trademark notice). Generated models must be trained according to the corresponding technique. In an alternative embodiment, the system may automatically select the extraction technique to be utilized at each level for each generated model based on factors such as the average sample size, the number of structural levels as described in the metadata definition, or the number of states at each level and so on.

In another possible embodiment, trained models are utilized by the system to label new samples, in an automated and incremental fashion, allowing a new sample to be created from an unlabeled document. In order to do that, the system applies the extraction technique related to the trained model to an unlabeled document provided as a sample. No information is effectively extracted or stored by the system. Instead, the system simply labels the content of that document, and stores it along with the other samples. Users can then verify that the sample was labeled accordingly, and the system must allow them to perform any necessary adjustments to the content of that sample.

In yet another possible embodiment, the system allows the execution of an additional testing step after training in order to estimate the precision of generated models before proceeding to extraction. During the tests, one part of the stored samples is utilized by the system to generate and train models, while the other part of the samples is retained for testing. The testing step consists essentially in applying trained models to the original (unlabeled) content of test samples, with any extracted content being subsequently discarded. Then, the ratio between the amount of correctly extracted information and the amount of originally labeled information is calculated by the system. Model precision is estimated based on that ratio. Note that the selection of which samples should be utilized by the system for testing may be random. When the selection is random, the set of samples is partitioned based on values set in the system configuration (e.g. train on 60% of the samples and test on the remaining 40% of the samples).

In a preferred embodiment, the extraction step can be initiated for a given document collection as soon as it is associated with trained models. However, extraction is only allowed to start when models trained for that collection are up to date with regard to its metadata definition and samples. Otherwise, a new training session must be executed in order for the system to update such models. Yet in such a preferred embodiment, information is automatically extracted and validated by the system as new documents are inserted into the corresponding collection. The extracted information is stored along with original document contents according to a logical scheme derived from the metadata definition associated with that collection so it can be immediately managed.

In a more specialized and preferred embodiment, the system constituting the present invention is implemented by one or more computer systems. A computer system is understood as being any combination involving a CPU (central processing unit), a logical bus for communication with this CPU, memory or storage devices, interfaces for connecting to other devices or equipment, as well as computer programs to operate the system.

In this preferred embodiment, services implemented by said system are available to users through a set of high-level commands. These commands are interpreted and translated into internal programming calls that perform the requested services as they are received by the system. Table 14 contains a brief description of the commands offered by the system and serves as a reference to the examples presented below. Note that this set of commands is specific to this embodiment of the present invention. Alternative embodiments might make such system services available through different commands or through an application program interface (API) with subroutines that correspond to the services in question.

With respect to the method that constitutes this invention, this preferred embodiment utilizes commands available in the system for performing each of its steps. Table 1 shows an example of a command sequence utilized in the preparation step. The example starts with the creation of a new document collection (line 1). Then, it provides a metadata definition (lines 2-3) and respective samples (lines 4-7) to the collection in question.

TABLE 1
Example of command sequence for the preparation step

| LINE | COMMAND |
|---|---|
| 1 | create document collection Official_Gazette |
| 2 | alter document collection Official_Gazette set definition |
| 3 | from http://localhost/og/official_gazette_notices.xsd |
| 4 | alter document collection Official_Gazette add sample sample_1 |
| 5 | from http://localhost/og/og_notices_sample_1.xml |
| 6 | alter document collection Official_Gazette add sample sample_2 |
| 7 | from http://localhost/og/og_notices_sample_2.xml |
| 8 | . . . |

In this preferred embodiment, a document collection is basically an area in system memory for the storage of all content related to a group of documents with similar structure and which may therefore be described by the same metadata definition and represented by the same set of samples. Samples added to the collection are labeled in XML (eXtensible Markup Language). The metadata definition, in turn, is supplied by an XSD (XML Schema Definition). If necessary, the XSD may be generated automatically from the XML markup in the samples. Table 2 contains an example of XSD providing a metadata definition similar to that depicted in FIG. 2.

TABLE 2
Example of XSD utilized for defining metadata

| LINE | XML CODE |
|---|---|
| 1 | <?xml version=“1.0” encoding=“UTF-8”?> |
| 2 | <!-- inpi_marcas.xml schema --> |
| 3 | <xsd:schema xmlns:xsd=“http://www.w3.org/2001/XMLSchema” version=“1.0”> |

| | |
|---|---|
| 4 | <xsd:element name=“official-gazette”> |

| | |
|---|---|
| 5 | <xsd:complexType mixed=“true”> |

| | |
|---|---|
| 6 | <xsd:sequence> |

| | |
|---|---|
| 7 | <xsd:element name=“header” minOccurs=“1”> |

| | |
|---|---|
| 8 | <xsd:complexType mixed=“true”> |

| | |
|---|---|
| 9 | <xsd:sequence> |

| | |
|---|---|
| 10 | <xsd:element name=“issue-no” type=“xsd:integer” |

| | |
|---|---|
| 11 | minOccurs=“1”/> |

| | |
|---|---|
| 12 | <xsd:element name=“issue-date” type=“xsd:string” |

| | |
|---|---|
| 13 | minOccurs=“1”/> |

| | |
|---|---|
| 14 | </xsd:sequence> |

| | |
|---|---|
| 15 | </xsd:complexType> |

| | |
|---|---|
| 16 | </xsd:element> |
| 17 | <xsd:element name=“service-by-publication” minOccurs=“1”> |

| | |
|---|---|
| 18 | <xsd:complexType mixed=“true”> |

| | |
|---|---|
| 19 | <xsd:sequence> |

| | |
|---|---|
| 20 | <xsd:element name=“notice” type=“notice_type” |

| | |
|---|---|
| 21 | minOccurs=“1” maxOccurs=“unbounded”/> |

| | |
|---|---|
| 22 | </xsd:sequence> |

| | |
|---|---|
| 23 | </xsd:complexType> |

| | |
|---|---|
| 24 | </xsd:element> |

| | |
|---|---|
| 25 | </xsd:sequence> |

| | |
|---|---|
| 26 | </xsd:complexType> |

| | |
|---|---|
| 27 | </xsd:element> |
| 28 | <xsd:complexType name=“notice_type” mixed=“true”> |

| | |
|---|---|
| 29 | <xsd:sequence> |

| | |
|---|---|
| 30 | <xsd:element name=“registrant” type=“xsd:string” minOccurs=“1”/> |
| 31 | <xsd:element name=“address” type=“xsd:string” minOccurs=“1”/> |
| 32 | <xsd:element name=“reg-no” type=“xsd:integer” minOccurs=“0”/> |
| 33 | <xsd:element name=“trademark” type=“xsd:string” minOccurs=“1”/> |
| 34 | <xsd:element name=“action” type=“action_type” minOccurs=“1”/> |
| 35 | <xsd:element name=“action-no” type=“xsd:integer” minOccurs=“1”/> |

| | |
|---|---|
| 36 | </xsd:sequence> |

| | |
|---|---|
| 37 | </xsd:complexType> |
| 38 | <xsd:simpleType name=“action_type”> |

| | |
|---|---|
| 39 | <xsd:restriction base=“xsd:string”> |

| | |
|---|---|
| 40 | <xsd:enumeration value=“Cancellation”/> |
| 41 | <xsd:enumeration value=“Opposition”/> |
| 42 | <xsd:enumeration value=“Expiration”/> |

| | |
|---|---|
| 43 | </xsd:restriction> |

| | |
|---|---|
| 44 | </xsd:simpleType> |

| | |
|---|---|
| 45 | </xsd:schema> |
| 46 | |

In this preferred embodiment, XSD element declarations are utilized to describe both the elements and information of interest to extract from documents. More specifically, leaf XSD element declarations associated with a simple data type (e.g. integer, string, etc.) describe the information of interest at its finest level (e.g. the element registrant at line 30 of Table 2), whereas element declarations of a complex data type (i.e., complexType) describe a structure which information should be contained in (e.g. the element notice at line 20 of Table 2). Additional declarations in XSD elements may also be incorporated as part of the metadata definition kept by the system. The type of grouping (e.g. sequence, choice, all) declared for complex types is particularly important because it allows the system to determine the possible label sequences to be produced. The declaration mixed=“true” present in a complex data type declaration (as in notice type at line 28 of Table 2) enables the system to recognize when information of interest appears intermixed with text content. Also, declarations of minimum and maximum occurrences (i.e., minOccurs and maxOccurs) assigned to a XSD element allow the system to identify when a given element or information is optional and when they may repeat within the text.

Other possible embodiments may use alternative languages similar to XSD, such as document type definitions (i.e., DTDs) and Relax NG, as a way to define metadata. In general, any alternative that is capable of accommodating the descriptors required by a metadata definition is considered an application of the method and system described in this invention. However, for this preferred embodiment where samples are provided in XML, XSDs are a particularly suitable choice. This is due to the fact that there are several tools available to check the consistency of XML documents from XSDs, in a process called validation. Besides, as a XSD is itself a XML document, it can be easily processed by the system with existing XML processing tools.

In this preferred embodiment, an XSD and respective XML samples remain associated with a document collection while stored in the system. For editing or viewing purposes, the system provides commands to retrieve the XSD and XML samples for a given document collection. Table 3 shows an example with these commands (lines 1-3). Note that similar system embodiments may use storage formats more efficient than plain XML to internally keep metadata and samples. However, in such embodiments, both XSDs and XML samples should be properly reconstructed by the system based on stored content.

TABLE 3
Commands for retrieving metadata and samples

| LINE | COMMAND |
|---|---|
| 1 | inspect document collection Official_Gazette get definition |
| 2 | inspect document collection Official_Gazette get sample |
| | sample_1 |
| 3 | inspect document collection Official_Gazette get sample |
| | sample_2 |
| 4 | . . . |

Yet in this preferred embodiment, samples are labeled by means of XML tags introduced within the original text, according to the element structure described in the corresponding XSD. Table 4 contains an example of an XML document sample labeled according to the XSD in Table 2.

TABLE 4
Example of a labeled XML Document Sample

| LINE | XML CODE |
|---|---|
| 1 | <?xml version=“1.0” encoding=“UTF-8”?> |
| 2 | <official-gazette> |
| 3 | <header> |
| 4 | OFFICIAL GAZETTE of the TRADEMARK OFFICE |
| 5 | |
| 6 | Issue Number <issue-no>12345</issue-no> |
| 7 | <issue-date>August 17, 2043</issue-date> |
| 8 | </header> |
| 9 | ... |
| 10 | <service-by-publication> |

| | |
|---|---|
| 11 | Service by Publication |

12

| | |
|---|---|
| 13 | A notice to the registration of the mark in the application identified below having been |

| | |
|---|---|
| 14 | filed, and the notice of such proceeding sent to applicant at the last known address having |
| 15 | been returned, notice is hereby given that within thirty days of this publication, the action |
| 16 | will proceed as in the case of default. |
| 17 | |
| 18 | <notice> |
| 19 | <registrant>Lumbi Zumb Solutions, LLC</registrant>, <address>Chesapeake, |
| 20 | Virginia</address>, Registration No. <reg-no>90129393</reg-no> for the mark |
| 21 | <trademark>“LUMBI CALL”</trademark>, <action>Cancellation</action> No. <action- |
| 22 | no>10051101</action-no>. |
| 23 | </notice> |
| 24 | |
| 25 | <notice> |
| 26 | <registrant>Mind Miner, INC.</registrant>, <address>Las Vegas, CA</address>, |
| 27 | Application No. 71112033, for the mark <trademark>“MMIND CONNECT”</trademark>, |
| 28 | <action>Opposition</action> No. |
| 29 | <action-no>91189495</action-no>. |
| 30 | </notice> |
| 31 | ... |
| 32 | |

| | |
|---|---|
| 33 | THOMAS M. SMITH |
| 34 | Paralegal Specialist |

| | |
|---|---|
| 35 | </service-by-publication> |
| 36 | ... |
| 37 | </official-gazette> |
| 38 | |

One of the advantages of utilizing the XML format for labeling samples is that any text editor allows the user to perform this task. Other similar embodiments may offer sophisticated graphical environments to visualize and label samples by inserting XML tags around user selected content. After samples have been labeled, any implementation compatible XML parser can be utilized by the system to validate those samples and thus ensure that their mark up is consistent with the metadata supplied in the corresponding XSD. Samples that have been successfully validated may be utilized by the system during the training step. Table 5 exemplifies the usage of commands for validating samples (lines 1-2) of a given collection in this preferred embodiment.

TABLE 5
Commands for validating samples

| LINE | COMMAND |
|---|---|
| 1 | alter document collection Official_Gazette validate sample |
| | sample_1 |
| 2 | alter document collection Official_Gazette validate sample |
| | sample_2 |
| 3 | . . . |

When documents or samples are provided in a file format other than XML, such as PDF, HTML, DOC, RTF, etc., the system must convert them to the XML format. In this preferred embodiment, such conversion is implemented through document import modules that can be plugged into the system (i.e., plug-ins). The import consists essentially in generating an XML document from the contents of the original document preserving, where possible, features related to the appearance and formatting of the text (e.g., font size, typeface and style, alignment, etc.). These features may be easily represented by special XML processing instructions or XML entities incorporated into the text. The possibility of incorporating features into imported content is not restricted to formatting features. Additional features that eventually add knowledge to the models during training and extraction could be incorporated by an import module with such capability.

In this preferred embodiment, the system is also capable of automatically generating an XSD based on the XML tags observed in samples and the contents bound within these tags. More specifically, for XML tags found in samples to contain only text (i.e., that do not contain inner tags), the system generates simple data type XSD element declarations. It is up to the system to identify whether the tagged content is numeric, alphanumeric, or even an enumeration of possible values, and to assign a compatible simpleType to the corresponding element. As for XML tags that include inner tags, the system generates XSD element declarations that belong to complex data types. In that case, the system analyzes the sequence in which inner tags appear in each sample in order to determine the most appropriate kind of grouping (e.g. sequence, choice, all) for nested element declarations belonging to the complexType being generated. After generating a XSD from samples, the system takes those samples as already validated according to that XSD. Note that the generated XSD will replace a previously existing XSD, if one is available. Table 6 shows an example with commands to generate a XSD automatically from the samples in this preferred embodiment. Samples are initially added to the collection (lines 1-4). After that (line 5), these samples are utilized by the system to generate the XSD relative to that collection. The generated XSD can be later retrieved (through the inspect command) and modified according to user needs.

TABLE 6
Command sequence for generating a XSD from samples

| LINE | COMMAND |
|---|---|
| 1 | alter document collection Official_Gazette add sample sample_1 |
| 2 | from http://localhost/og/og_notices_sample_1.xml |
| 3 | alter document collection Official_Gazette add sample sample_2 |
| 4 | from http://localhost/og/og_notices_sample_2.xml |
| 5 | alter document collection Official_Gazette build definition from |
| | samples |
| 6 | . . . |
| 7 | |

In this preferred embodiment, document collections containing samples already validated from their XSD are taken by the system as properly prepared and can therefore be submitted to training Table 7 shows an example in which a training session is initiated for a given document collection (line 1).

TABLE 7
Command for initiating a training session

| LINE | COMMAND |
|---|---|
| 1 | alter document collection Official_Gazette start training |
| 2 | . . . |

Yet in this preferred embodiment, the extraction models generated in the training step are CRF (Conditional Random Fields) models. In its default configuration, the system utilizes segmentation models generated for complex type XSD element declarations in order to extract smaller and smaller segments, thus successively decomposing document contents based on that XSD element structure. CRF models are generated for each element nesting level, as illustrated by FIGS. 4A, 4B and 4C. When that type of segmentation is not desirable, users must configure the system to disable its usage. In this case, the system will generate a single CRF model whose topology represents a linearized version of the structure described in a XSD at all its levels (similar to the model in FIG. 3). The states and transitions of each CRF are generated according to XSD element declarations. In particular, the type of grouping associated with composite elements allows for identifying the necessary transitions between states corresponding to their sub-elements. Artificial states are introduced into the CRF to deal with the text attached to the information contained in elements that include the declaration mixed=“true”. The number of occurrences of each element declaration (either of a simple or complex type) is utilized to identify additional transitions between the corresponding CRF states. Similarly to the process described earlier, the various aspects described in a XSD with respect to each element are therefore taken into account to determine the topology of the CRFs generated during training. Other embodiments may generate and train classifier models (such as maximum entropy classifiers) for recognizing the beginning and end of the text at the outer levels of the structure described in a XSD. This option would ensure more efficient training even in cases where samples contain very long text sequences.

During training, the referred system converts the content of already validated samples to an appropriate format to train the CRFs. This format is similar to a matrix containing one row for each token in the text of the sample. At each line, the features present in that text position, and the corresponding label, are given. Table 8 shows an excerpt of a sample in this format. This example assumes that some of the features included in the CRF are generated from preexisting functions in the system (e.g., feature f_nn, to indicate that the token is a noun). Other features are generated from functions that analyze the metadata definition and the content of samples in order to incorporate domain knowledge during training (e.g. f_begin_OFFICIAL to indicate a text segment that begins with the word “OFFICIAL”).

TABLE 8
Example of a sample in a training format

| TOKEN | FEATURES | LABEL |
|---|---|---|
| OFFICIAL | f_upper, f_nn, | <header.txt_0> |
| | f_begin_OFFICIAL, . . . | |
| GAZETTE | f_upper, f_nn, . . . | <header.txt_0> |
| of | f_pp, . . . | <header.txt_0> |
| the | f_dt, . . . | <header.txt_0> |
| TRADEMARK | f_upper, f_nn, . . . | <header.txt_0> |
| OFFICE | f_upper, f_nn, . . . | <header.txt_0> |
| Issue | f_nn, . . . | <header.txt_0> |
| Number | f_nn, . . . | <header.txt_0> |
| 12345 | f_numeric, f_prev_is_Number, | <header.issue-no> |
| | . . . | |
| August | f_nn, f_is_month, | <header.issue-date> |
| | f_begin_AUGUST . . . | |
| 17 | f_numeric, f_prev_is_month . . . | <header.issue-date> |
| , | f_punctuation, f_comma, . . . | <header.issue-date> |
| 2043 | f_numeric, | <header.issue-date> |
| | f_previous_is_comma . . . | |
| . . . | . . . | . . . |

In this preferred embodiment, generated CRF models are trained by numerical optimization methods as proposed in “Shallow parsing with conditional random fields” (HLT-NAACL-2003). Besides the command to start a training session, the system provides a command to stop training even if numerical convergence has not yet been reached. When this command is executed, the numerical process is interrupted by the system and model parameters will be those estimated to the point where training was stopped. Table 9 exemplifies the use of such command (line 1). This example also demonstrates the use of a command to obtain data related to the last training session (line 3). Such data essentially includes the state of the training session (new, started or finished), number of iterations completed, model parameters and estimated values.

TABLE 9
Command for stopping a training session

| LINE | COMMAND |
|---|---|
| 1 | alter document collection Official_Gazette stop training |
| 2 | . . . |
| 3 | inspect document collection Official_Gazette get training info |
| 4 | . . . |

In this preferred embodiment, generated models and estimated parameters are stored by the system when training is finished, and remain associated with the document collection in question. A collection that has an already trained model can be utilized to help with labeling new samples. The sample in this case is treated as any document which needs to be labeled. Internally in the system, that corresponds to having the text of the sample stored in the format of Table 8, but whose label column is still empty and needs to be automatically filled out by the trained model. Once labeled, the table content is used by the system to insert the XML tags into the sample, according to the labels that have been assigned to the text. The newly labeled sample is taken as validated by the system, and can be utilized in subsequent training. The command to label samples is exemplified in Table 10. In this example, an unlabeled XML sample is created out of a document imported in the PDF format (lines 1-2). Then (line 3), said sample is submitted to the automatic labeling process by the corresponding command (line 3).

TABLE 10
Commands for labeling an imported sample

| LINE | COMMAND |
|---|---|
| 1 | alter document collection Official_Gazette add sample sample_1 |
| 2 | from http://localhost/og/og_notices_sample_1.pdf |
| 3 | alter document collection Official_Gazette label sample sample_1 |
| 4 | . . . |

Yet in this preferred embodiment, the system also provides commands to submit a collection to a testing step. These commands are shown in Table 11. As the test session is initiated (line 1), the system executes a training session including only part of validated samples (randomly chosen at a defined percentage according to user configuration) and apply the models to label remaining samples. Next (line 3), the inspect command is utilized to obtain information about test results (or their progress, in case the test session has not been completed yet).

TABLE 11
Commands utilized in the testing step

| LINE | COMMAND |
|---|---|
| 1 | alter document collection Official_Gazette start testing |
| 2 | . . . |
| 3 | inspect document collection Official_Gazette get testing info |

In this preferred embodiment, the insert command is utilized to extract information from a document and insert it into the collection in question. Internally, the insert command converts the document provided as input to a format similar to that of Table 8, except that the column with labels will still be empty. This command then utilizes trained models of that collection to automatically label each text token in order to complete the table. The label assigned indicates the element (or element path) in which the text token is contained (e.g. <header.issue-date>). This allows the system to reconstruct the original document contents while the corresponding XML tags are introduced into the text. The document that results from this procedure, now a structured XML document, is stored by the system in the document area related to the collection in question. Therefore, in this embodiment, document contents are fully tagged and stored along with information of interest in a XML document. In alternative similar embodiments, the system may validate the resulting XML document against the corresponding XSD before it is stored in a collection (any failures eventually detected in this validation must reported during the execution of insert command). Other embodiments of the system may store information in an internal format other than XML, but it is important that this format establishes a correspondence between the extracted text segments and the elements of the structure described in the metadata, thus preserving the context in which that information was found. Table 12 presents an example of the commands utilized in the extraction step. Each document is tagged and stored in the collection by the insert command (lines 1-3). Extracted information is then perpetrated in the system through the commit command (line 5).

TABLE 12
Commands utilized in the extraction step

| LINE | COMMAND |
|---|---|
| 1 | insert document from http://localhost/og/og_doc_1.pdf into |
| | Official_Gazette |
| 2 | insert document from http://localhost/og/og_doc_2.pdf into |
| | Official_Gazette |
| 3 | insert document from http://localhost/og/og_doc_3.pdf into |
| | Official_Gazette |
| 4 | . . . |
| 5 | commit |
| 6 | . . . |

In this preferred embodiment, the content stored in a document collection can be queried at any time through the select command, or removed by the delete command. Search expressions for these commands are specified by the XPath language. XPath expressions are interpreted and analyzed by the system according to the description provided by the XSD of the collection in question (i.e., the XSD defines the logical schema which will determine the valid queries for that collection). Consider the following query: find all service by publication notices in the Official Gazette issued in 2008 having the registrant name starting with ‘Mobile’. Table 13 shows the command (lines 1-4) containing the search expression for this query. The query result consists of XML nodes as specified in the XPath language. In alternative similar embodiments, XSLT (eXtensible Stylesheet Language Transformations) may be integrated into the system in order to allow query results to be automatically converted to other formats (e.g. HTML) and transferred to other systems. Such embodiments may also adopt other XML based languages for handling queries, such as XQuery, which is not only capable of querying information stored in the system, but also returning query results in the desired format.

TABLE 13
Command for querying extracted information

| LINE | COMMAND |
|---|---|
| 1 | select |
| 2 | /official-gazette[ends-with(header/issue_date,‘2008’)]/ |
| 3 | service-by-publication/notice[starts-with(registrant,‘Mobile’)] |
| 4 | from Official_Gazette |
| 5 | . . . |

In this preferred embodiment, commands are executed from a server process which remains indefinitely active. Other processes and remote applications may connect to this server at any point in time and request the execution of commands offered by the system. It is up to the server process the task of authenticating and managing remote connections, as well as responding appropriately to requests made through those connections. The server process receives requests with commands and passes them on to internal system modules responsible for executing such commands. Upon receiving the results of that execution from its internal modules, the server process sends this result back to the process that originally made the request. The server process must be able to receive and execute multiple requests simultaneously and to coordinate them so that stored content will not become corrupted or inconsistent. Implementation techniques traditionally associated with concurrent data management can be adopted to ensure consistency of stored information.

In this preferred embodiment, requests containing commands to be executed are sent to the server process through a communication protocol, which is determined by the system configuration. The system utilizes the http protocol for this task (the commands are either encoded in the connection url sent to the server or encapsulated in the body of the request via post, possibly through a standardized format such as SOAP). In alternative embodiments, secure variants of these protocols (e.g. https) can also be adopted to communicate with the server process. It is up to the client processes (or applications) the task of connecting to the server process through the expected system protocol and send requests containing commands to be executed.

Table 14 contains a brief description of the main commands offered by the system, in this preferred embodiment (parameters appear between “<” and “>”).

TABLE 14
System Commands

| COMMAND | DESCRIPTION |
|---|---|
| create document collection | Creates a new document collection named |
| <col_name> | <col_name> |
| alter document collection | Assigns the metadata defined by the XSD found at |
| <col_name> set definition | <url_xsd> to the collection named <col_name> |
| from <url_xsd> | |
| alter document collection | Adds to the collection named <col_name> a sample |
| <col_name> add sample | identified by <sample_name> whose content is |
| <sample_name> from | located at <url_sample> |
| <sample_url> | |
| alter document collection | Removes the sample identified by <sample_name> |
| <col_name> remove sample | from the collection named <col_name> |
| <sample_name> | |
| alter document collection | Creates a metadata definition from the contents of the |
| <col_name> build definition | samples added so far and assigns it to the collection |
| from samples | named <col_name> |
| alter document collection | Validates the sample identified by <sample_name> |
| <col_name> validate sample | that belongs to the collection <col_name> |
| <sample_name> | |
| alter document collection | Automatically labels the sample identified by |
| <col_name> label sample | <sample_name> that belongs to the collection |
| <sample_name> | named <col_name> |
| alter document collection | Starts a training session for the collection named |
| <col_name> start training | <col_name> |
| alter document collection | Stops the current training session for the collection |
| <col_name> stop training | <col_name> |
| alter document collection | Starts a testing session for the collection named |
| <col_name> start testing | <col_name> |
| alter document collection | Stops the current testing session for the collection |
| <col_name> stop testing | <col_name> |
| inspect document collection | Returns the contents of the XSD corresponding to the |
| <col_name> get definition | metadata definition assigned to the collection named |
| | <col_name>, if that exists |
| inspect document collection | Returns a list with the names of samples belonging to |
| <col_name> list samples | the collection named <col_name> |
| inspect document collection | Returns the XML contents of the sample identified by |
| <col_name> get sample | <sample_name> belonging to the collection named |
| <sample_name> | <col_name> |
| inspect document collection | Returns information on the training session related to the |
| <col_name> get training info | collection named <col_name> |
| inspect document collection | Returns information on the testing session related to the |
| <col_name> get testing info | collection named <col_name> |
| insert document from | Inserts the contents extracted from a document located |
| <document_url> into | at url <document_url> into the collection named |
| <col_name> | <col_name> |
| delete <xpath_expression> | Deletes the information satisfying the search expression |
| from <col_name> | <xpath_expression> from the collection named |
| | <col_name> |
| select <xpath_expression> | Returns the information contained in the collection |
| from <col_name> | named <col_name> satisfying the search |
| | expression <xpath_expression> |
| commit | Perpetrates all modifications performed by insert |
| | and delete commands since the completion of a |
| | training session or since the last time the commit |
| | command was successfully executed |
| rollback | Undoes all modifications performed by insert and |
| | delete commands since the completion of a training |
| | session or since the last time the commit command |
| | was successfully executed |

Furthermore, although specific embodiments of the invention have been described and depicted, the invention is not to be limited to the specific forms or arrangements of parts so described and depicted. The scope of the invention is to be defined by the claims appended hereto and their equivalents.

What is claimed is:

1. A method for extracting and managing information contained in electronic documents that comprises a “preparation” step in which one or more document samples are collected, a “training” step in which one or more extraction models are trained to have their parameters adjusted based on said samples, and an “extraction” step in which said one or more of extraction models are utilized to automatically extract information from one or more electronic documents, said method comprising:
utilizing metadata to describe the whole or part of the content available in said document samples through a structure that comprises one or more elements to describe said whole or part of the content and wherein each of said elements further comprises at least one type of information to be extracted from said one or more documents or further comprises at least one sub-element, and said structure describes at least one sequence in which information must be extracted from said documents; and
utilizing said metadata to automatically generate one or more extraction models, said models being generated by one or more processes that obtain as an input the whole or part of the description provided by said metadata and that produce as an output said extraction models.

2. The method of claim 1, comprising utilizing said metadata to store and manage the information extracted from documents by means of at least one logical storage schema for which at least one relation of correspondence with the structure described by said metadata is established.

3. The method of claim 1, comprising:
generating and training a first extraction model for extracting at least one document segment containing at least one information that is described in said metadata for a given sub-element of said structure;
generating and training a second extraction model for extracting from a document segment at least one information that is described in said metadata for that given sub-element of said structure; and
applying the first trained model to the whole or part of at least one of said documents to extract at least one document segment, then applying the second trained model to such segment in order to extract at least one information that is described in said metadata for that given sub-element of said structure.

4. The method of claim 1, wherein said document samples that are collected in the preparation step are tagged with labels indicating the type of information to which the text associated with said labels refers.

5. The method of claim 4, wherein said metadata are utilized in the preparation step to verify that label sequences present in the labeled samples are valid.

6. The method of claim 1, further comprising including an additional “testing” step that estimates the precision to be offered in the extraction step.

7. A system for extracting and managing information contained in electronic documents, wherein the system comprises one or more processing units (CPUs) and one or more memory devices configured and operated at least in part by means of the logic of computer programs through which one or more extraction models may be trained to have their parameters adjusted based upon one or more document samples and said models are utilized to automatically extract information from one or more electronic documents, said system comprising:
utilizing metadata to describe the whole or part of the content available in said document samples through a structure that comprises one or more elements to describe said whole or part of the content and wherein each of said elements further comprises at least one type of information to be extracted from said one or more documents or further comprises at least one sub-element, and said structure describes at least one sequence in which information must be extracted from said documents; and
utilizing said metadata to automatically generate one or more extraction models, said models being generated by one or more processes that obtain as an input the whole or part of the description provided by said metadata and that produce as an output said extraction models.

8. The system of claim 7, further comprising hardware or software logic for utilizing said metadata to store and manage the information extracted from documents by means of at least one logical storage schema for which at least one relation of correspondence with the structure described by said metadata is established by said system during or following extraction of said information.

9. The system of claim 7, further comprising hardware or software logic for:
generating and training a first extraction model for extracting at least one document segment containing at least one information that is described in said metadata for a given sub-element of said structure;
generating and training a second extraction model for extracting from a document segment at least one information that is described in said metadata for that given sub-element of said-structure; and
applying the first trained model to the whole or part of at least one of said documents to extract at least one document segment, then applying the second trained model to such segment in order to extract at least one information that is described in said metadata for that given sub-element of said structure.

10. The system of claim 7, wherein said document samples are tagged with labels indicating the information to which the text associated with said labels refers.

11. The system of claim 10, wherein said metadata are utilized to verify that label sequences present in said document samples are valid.

12. The system of claim 7, wherein the definition of said metadata is realized by means of an XML Schema Definition.

13. The system of claim 10, wherein said document samples are provided in a XML format and contain XML tags that identify the labeling assigned to text segments within said document samples.

14. The system of claim 13, wherein the definition of said metadata is realized by means of an XML Schema Definition and said system utilizes said XML Schema Definition to verify that the XML tags present in said document samples are valid.

15. The system of claim 14, wherein said XML Schema Definition is automatically generated from the XML markup that is contained in said document samples.

16. The system of claim 14, wherein said system automatically inserts the XML tags corresponding to labels into a new sample by utilizing a model that is already trained from said samples and from said XML Schema Definition.

17. The system of claim 7, wherein trained models are applied to part of said samples in order to automatically estimate the precision to be offered when extracting information.

18. The system of claim 7, further comprising a server process indefinitely running on at least one system server wherein other remote processes or applications can connect with said server at any given time to request the execution of the information extracting and managing services that are provided by the information extracting and managing portion of said system.
